(19) United States
(12) Patent Application Publication
(10) Pub. No.: US 2006/0243330 A1
(43) Pub. Date: Nov. 2, 2006

(54) Preset shower setting assembly

(76) Inventor: Power Abanto, Bergenfield, NJ (US)

Correspondence Address: Power Abanto, 101 West Central Avenue, Bergenfield, NJ, 07621, US

(21) Appl. No.: 11/117,927

(22) Filed: May 2, 2005

(51) Int. Cl. F16K 37/00

(52) U.S. Cl. 137/556.3

(57) ABSTRACT

A preset shower assembly kit having a dial indicator securable to the cold water controller and a second dial indicator securable to the hot water controller, there being disposed on the shower wall above the hot water controller and above the cold water controller, a decal plate, the dial indicator capable of sweeping through the arc of the decal plate when the hot water controller or the cold water controller is manipulated, the decal plate having demarcations formed thereon for water temperature, the decal plate cooperable with a user's individual adhesive indicia so as to mark on the decal plate the user's preferred setting of hot water and cold water in order to effectuate the fluid flow and temperature of the shower.

### BACKGROUND OF THE INVENTION

1. Field of the Invention

The present invention relates to shower assemblies, and in particular, shower assemblies where the hot water and the cold water are adjusted independently, the invention comprising a dial member attached to the hot and cold water controls, and an indicia secured to the wall of the shower behind the controls allowing the user to mark the indicia with the user's preferential settings for temperature and flow control.

2. Description of the Prior Art

Shower stalls or showers located in baths primarily utilize one of two means to control the temperature of the shower and the flow output of the shower during use. One means of control is the single handle controller which is pulled outwardly to initiate flow and control the strength of flow and turned to the right for cold water, and to the left for hot water, thereby causing the blending of the water to the desired temperature and flow rate with one controller.

Alternatively, showers are regulated by an individual cold water control and an individual hot water control. In this type of assembly, the user has to manipulate the controls individually and independently to achieve the desired flow rate and the desired temperature. This oftentimes proves difficult and time consuming and also wasteful of water. Since the controls are independent they had no indicia with respect to settings. Each time the user wished to use the shower, the user had to make minor adjustments in order to achieve the desired flow rate and temperature. Still further, the individual user is likely to maintain the shower flow after he obtains the desired shower flow even though he does not need that flow for the actual cleansing, such as scrubbing his body with soap and water before rinsing it off. However, the individual user will maintain that flow because of the difficulty of obtaining it. The individual user will also be tempted to maintain the temperature and flow as originally set, even though it is not required for the cleansing activity being undertaken, and thus wastes water and energy.

Applicant's invention has particular application to this type of shower assembly where the hot water and the cold water are controlled by independent controllers. Applicant's assembly kit allows a user or user's to establish a visible indicia of the setting which they desire. Once this indicia is established, the user or users need only to manipulate the hot water and cold water controllers to alignment with this indicia to achieve the desired flow rate and temperature.

### OBJECTS OF THE INVENTION

An object of the present invention is to provide for a novel assembly kit for use with a hot water controller and a cold water controller in a shower facility to allow the user or users to establish a visible indicia identifying the desired amount of fluid flow and the desired temperature such that this indicia can be utilized each time the user desires to take a shower.

A further object of the present invention is to provide for a novel assembly kit setting the hot water controller and the cold water controller of a shower assembly to the flow rate and temperature desired by the user and therefore avoid the waste of water and energy.

A still further object of the present invention is to provide for a novel assembly kit which allows the user or users to establish a visible indicia for their desired flow rate and temperature of the shower, which allows multiple users to establish their own personalized indicia for the same shower assembly.

A still further object of the present invention is to provide for a novel assembly kit for establishing an indicia with respect to the hot water and cold water controllers of a shower assembly which is easy to install and will not be effected by exposure to soap and water.

A still further object of the present invention is to provide for a novel assembly kit for establishing an indicia with respect to the hot water and cold water controllers of a shower assembly, which allows the user to preset different temperatures and flow settings so that the individual user can shift back and forth between settings while taking a shower, thus conserving water and energy.

A still further object of the present invention is to provide for a novel assembly kit for establishing an indicia with respect to the hot water and cold water controllers of a shower assembly which allows an individual user or users to quickly and precisely obtain the desired settings for the hot water and the cold water and the amount of flow of each, thus conserving water and energy.

### SUMMARY OF THE INVENTION

A preset shower assembly kit having a dial indicator securable to the cold water controller and a second dial indicator securable to the hot water controller, there being disposed on the shower wall above the hot water controller and above the cold water controller, a decal plate, the dial indicator capable of sweeping through the arc of the decal plate when the hot water controller or the cold water controller is manipulated, the decal plate having demarcations formed thereon for water temperature, the decal plate cooperable with a user's individual adhesive indicia so as to mark on the decal plate the user's preferred setting of hot water and cold water in order to effectuate the fluid flow and temperature of the shower.

### BRIEF DESCRIPTION OF THE DRAWINGS

These and other objects of the present invention will become apparent, particularly when taken in light of the following illustrations wherein:

FIG. 1 is a cross section of the shower wall, a cold water controller, and the indicia assembly kit of the present invention;

FIG. 2 is a front planar view of the hot water controller and cold water controller with the indicia assembly kit installed for a single user; and

FIG. 3 is a front planar view of the hot water controller and cold water controller with the indicia assembly kit installed for multiple users.

### DETAILED DESCRIPTION OF THE INVENTION

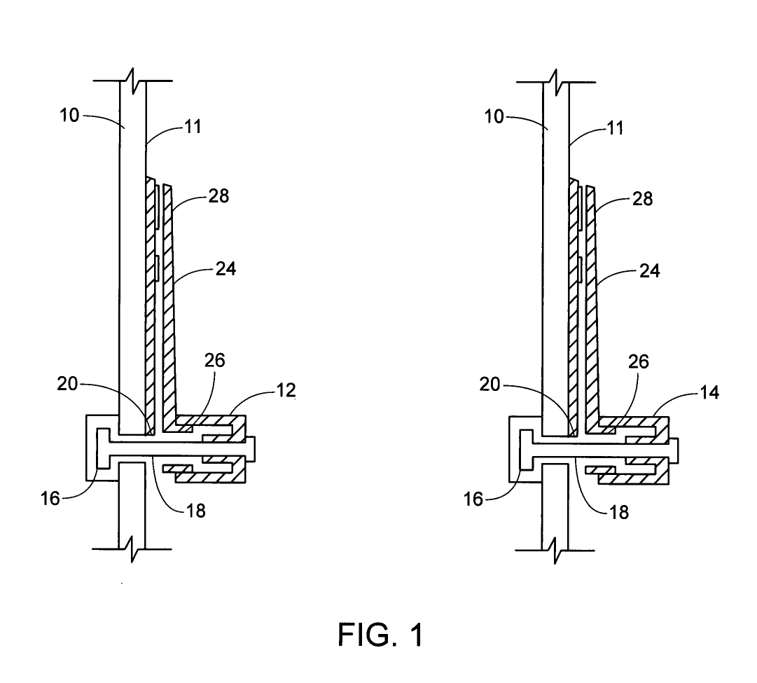

FIG. 1 is a cross sectional view of a shower wall, shower handle, and the assembly kit of the present invention installed. Shower wall 10 would normally be fabricated from tile, fiberglass, or other waterproof material. The hot water and cold water pipes (not shown) would normally be positioned behind shower wall 10. On the face 11 of shower wall 10 would be mounted shower control handles 12 and 14 for control of the hot water and the cold water. Shower handle 12 (hot water) as illustrated in FIG. 1 would be in communication with a valve means 16 positioned behind the shower wall 10 which would control the flow of hot water. This is accomplished by means of a shaft 18 which extends through a preformed gap 20 in shower wall 10 to the valve means 16. A similar arrangement shown in FIG. 1 would apply to shower control handle 14 for cold water.

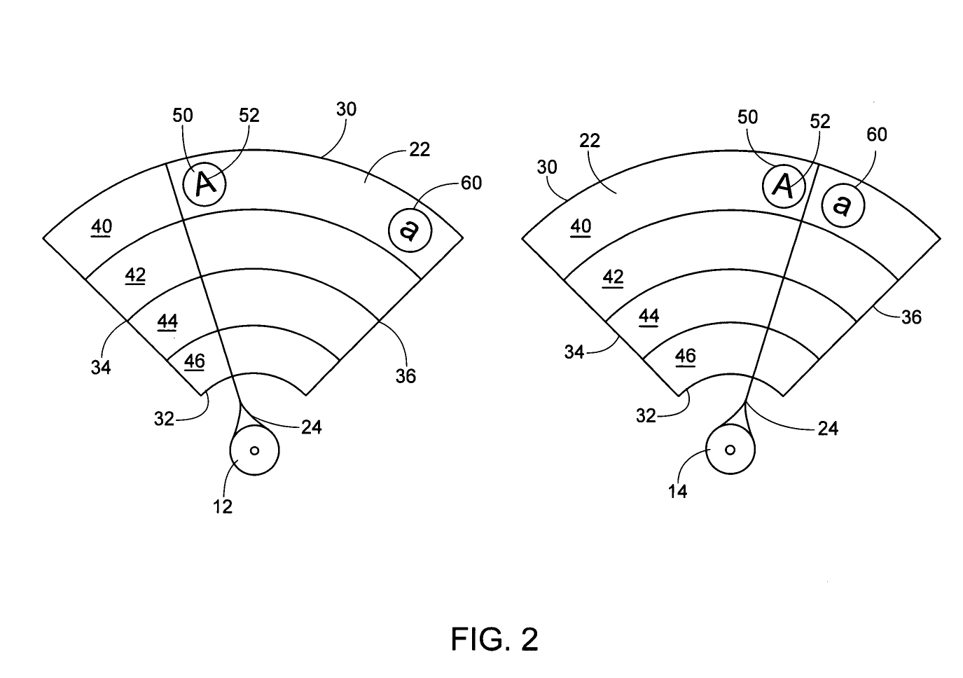

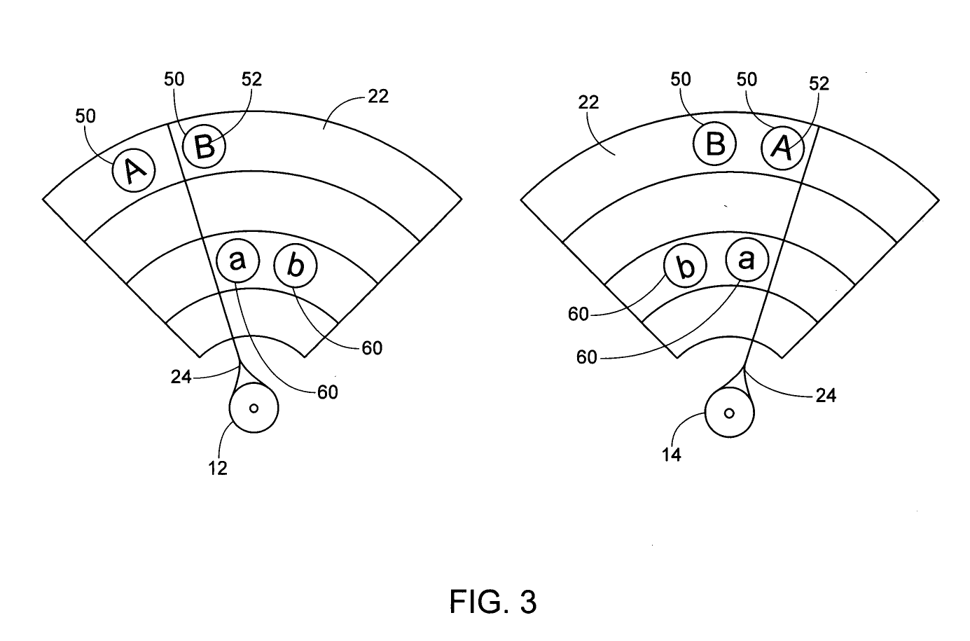

In normal operation the user would have to selectively adjust the hot water controller and cold water controller 12 and 14 to achieve the correct amount of fluid flow from the shower head and the correct temperature of that fluid flow by rotating each individual controller counterclockwise from the closed of off position. Applicant's device allows for a user or multiple users to preset the desired setting for the hot water controller and cold water controller 12 and 14 for the amount of flow that the user prefers and the temperature which the user prefers. This is accomplished by a decal plate 22 which is affixed to the shower wall 10 above the respective hot water controller 12 and cold water controller 14. (See FIGS. 2 and 3) The decal plate 22 is in the form of an arc as will be more fully described hereafter. Two dial indicators 24 each having a first end 26 which are secured to the hot and cold water controllers 12 and 14. Each dial indicator 24 consists of a stem 28 which extends from first end 26 for a distance equal to the uppermost arc portion of decal plate 22 as described hereafter. Dial indicators 24 being affixed at their first ends 26 to the hot water controller 12 and the cold water controller 14, will rotate in a counterclockwise arc each time the hot water controller or the cold water controller 12 or 14 is moved from an off or closed position to an on or open position. Dial indicators 24 would be affixed to hot water controller 12 and cold water controller 14 when the user has achieved the desired flow rate and temperature.

FIG. 2 is a front planar view of the hot water controller and cold water controller 12 and 14 with the decal plates 22 and dial indicators 24 in position. Decal plates 22 are in the form of an arc having an arcuate upper edge 30 and an arcuate lower edge 32 with linear ends 34 and 36. Decal plates 22 are divided into a series of arcuate gradations which may be color coded and which are designed to indicate a desired temperature range of the water emanating from the shower head. In one such example, the uppermost arcuate gradation 40 would represent a fluid flow from the shower head of hot temperature and could be color coded red. The next lower gradation 42 could represent a warm fluid flow from the shower head and could be gradated light brown. The next lower gradation 44 could represent body temperature fluid flow from the shower head and could be color coded white with the lower most arcuate gradation 46 representing a cool or cold shower and color coded blue. These color coded gradations are given as an example only and it will be recognized that alternative indicia or colors of temperature could be used. Decal plate 22 may be formed as a decal with adhesive on its rear face with a suitable release layer.

The decal plate 22 is designed to accept an additional decal indicia in the form of a dot decal 50 which may further have an indicia 52 thereon for example in the form of a letter or initial from the user's first or last name. This dot decal 50 indicia is positioned both on the decal plate 22 for the hot water controller 12 and the decal plate 22 for the cold water controller 14 to identify the setting for each controller by the user for the particular type of shower preferred by the user.

As an example, in FIG. 2, if user A desired a certain flow and temperature, the A dot decal 50 having user A's indicia 52 thereon would be positioned in upper gradation 40 decal plate 22 where it would align with dial indicator stem 28 on the hot water controller 12 when the hot water controller 12 was opened the desired amount. A similar dot decal 50 having the user's letter initial “A” on it would be positioned in the upper gradation 40 of decal plate 22 associated with the cold water controller 14 at a point which would allow sufficient cold water to mix with the hot water to achieve the correct temperature desired by the user. As illustrated in FIG. 2, the dot decals 50 and letter indicia 52 would be positioned so that the user could align the cold water controller dial stem 24 indicator with the dot decal and the hot water controller dial stem 24 indicator with its respective dot decal 50. Once having established these two settings, the user would merely turn the hot water controller 12 until the dial stem indicator 28 was aligned with the dot decal 50 associated with the hot water controller 12 and turn the cold water controller 14 until the dial stem indicator 24 was aligned with the dot decal 50 on the decal plate 22 for the cold water controller 14. The settings, thus being preset, allow the user on repetitive showers to visible set the hot water controller and the cold water controller to the correct setting to achieve the desired flow rate and temperature for the shower. If more than one individual were using the same shower, the other individual could utilize separate dot decals with different indicia than user A's indicia to identify the second user's desired settings for the type of shower they preferred.

Still further, if a user preferred a full strength hot shower for bathing his body, the dot decals 50 indicia could be positioned on the decal plate as illustrated in FIG. 2. However if user A preferred a low flow rate hot shower for perhaps washing his or her hair, the user could position additional dot decals 60 on the respective decal plates 22 for the hot water controller 12 and the cold water controller 14 to preset and mark the lower flow settings desired by the user. The user could distinguish these low flow setting dot decals by a lower case letter such as “a” or other suitable indicia as illustrated in FIG. 2.

The indicia and shape of the dot decals 50 or 60 are given for explanation purposes only. The dot decals 50 or 60 could be of any geometric shape and the user could adopt a marking indicia for the dot decals 50 or 60 of his or her choice. The purpose being that the dot decals 50 or 60 in cooperation with the decal plates 22 and dial indicators 24 allow an individual to preset the hot water controller 12 and cold water controller 14 openings for the desired fluid flow and temperature for taking the type of shower or showers they desire. The system further allows for multiple users to preset the same shower to their desired fluid flow and temperatures by merely adopting a different indicia to be placed on their respective dot decals.

FIG. 3 illustrates decal plate 22 for hot and cold water controllers 12 and 14 for two different users in which the dot decals 50 or 60 have different letter indicia 52 to distinguish the users.

The use of the indicia and the indicators disclosed herein allow for a user or multiple users to preset their temperature settings and flow settings in a shower assembly. The indicia and indicators allow the user or users to quickly and accurately set the temperature and flow of the shower so as not to waste water and energy while attempting to obtain the desired temperature and flow. The indicia and indicators also allow the user or users to change the temperature or flow of the shower during the taking of the shower accurately and precisely again allowing the user to save water and energy. Still further, the use of the indicator and indicia will allow the user to vary the temperature and flow of water during the cleansing procedure, thus saving water and energy whereas the user may be reluctant to vary the temperature and flow during the cleansing procedure because of the inaccuracy of trying to re-obtain the desired temperature and flow without the indicia and indicator assembly.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A preset shower setting assembly kit for a shower having an independent hot water controller and an independent cold water controller, the preset shower setting assembly kit comprising:
a pair of dial indicators, each of said dial indicators having a first end and a second end, said first end of each of said dial indicators securable to said hot water controller and said cold water controller respectively;
a pair of decal plates, one decal plate adhesively secured above said hot water controller and said cold water controller respectively;
a plurality of decal indicia selectively securable to said pair of decal plates and alignable with said respective dial indicators secured to said hot water controller and said cold water controller to identify desired settings of said hot water controller and said cold water controller for desired flow rate and temperature of said shower for a user.

2. The preset shower setting assembly kit in accordance with claim 1 wherein each of said decal plates is arcuate in shape having arcuate gradations, said arcuate gradations indicative of desired temperature of said shower.

3. The preset shower setting assembly kit in accordance with claim 2 wherein said gradations are indicators of shower temperature ranging from cool, to body temperature, to warm, to hot.

4. The preset shower setting assembly kit in accordance with claim 1 wherein said pair of dial indicators having said first end secured to said hot water controller and said cold water controller, has said second end extending from said respective hot water controller and said cold water controller so as to span said decal plate when said hot water controller and said cold water controller are manipulated for alignment with one of said plurality of decal indicia affixed to said decal plate.

5. The preset shower setting assembly kit in accordance with claim 1 wherein said plurality of decal indicia are different for each user so as to identify said respective user's preferred hot water controller setting and cold water controller setting for said shower.

6. A method of allowing a user or multiple user's of a shower, the shower having independent hot water controller and an independent cold water controller, to preset the hot water controller and cold water controller for desired water flow and temperature of the respective user, the method comprising:
a. affixing a decal plate to a shower or wall above the respective cold water controller and hot water controller;
b. securing a dial indicator to the hot water controller and the cold water controller, each dial indicator having a first end secured to the respective hot water controller and cold water controller and a second end which spans the decal plate above the respective controller;
c. initiating a shower flow by turning said hot water controller and said cold water controller so as to achieve the quantity of flow and temperature of the flow as desired by the user;
d. placing a decal indicia on said decal plate of said hot water controller, underneath said dial indicator of said hot water controller and placing a decal indicia on said decal plate of said cold water controller underneath said dial indicator of said cold water controller thereby presetting the respective hot water controller and cold water controller for the respective user; and
repeating steps c and d for each additional user.
